(19) United States
(12) Patent Application Publication
(10) Pub. No.: US 2008/0090452 A1
(43) Pub. Date: Apr. 17, 2008

(54) Battery adapter

(76) Inventors: David Rose, West Palm Beach, FL (US); Anthony D'Andrea, Jupiter, FL (US); Lawrence A. Miller, Dover, MA (US)

Correspondence Address: Mark J. Pandiscio;Pandiscio & Pandiscio, P.C., 470 Totten Pond Road, Waltham, MA, 02451-1914, US

(21) Appl. No.: 11/804,091

(22) Filed: May 17, 2007

Related U.S. Application Data
(60) Provisional application No. 60/801,012, filed on May 17, 2006.

(51) Int. Cl. H01R 3/00; H01M 2/20; H02J 7/00

(52) U.S. Cl. 439/500; 429/121; 320/127

(57) ABSTRACT

A battery adapter, the battery adapter comprising: a body having a first portion and a second portion, wherein the first portion is configured so as to mechanically and electrically connect to an electrical device, and the second portion is configured so as to mechanically and electrically connect to a battery, wherein the electrical device and the battery are characterized by different form-fit factors; wherein the first portion is electrically connected to the second portion so that a battery connected to the second portion can power an electrical device connected to the first portion. A battery adapter, the battery adapter comprising: a body having a first portion and a second portion, wherein the first portion is configured so as to mechanically and electrically connect to an electrical device, and the second portion is configured so as to mechanically and electrically connect to a battery; wherein the first portion is electrically connected to the second portion so that a battery connected to the second portion can power an electrical device connected to the first portion; and further wherein the battery adapter further comprises the logic circuitry associated with a smart battery, in order that the battery adapter can provide smart battery functionality when the battery comprises a non-smart battery.

### REFERENCE TO PENDING PRIOR PATENT APPLICATION

This patent application claims benefit of pending prior U.S. Provisional Patent Application Ser. No. 60/801,012, filed May 17, 2006 by David Rose et al. for BATTERY ADAPTER (Attorney's Docket No. GLOBALTECH-1 PROV), which patent application is hereby incorporated herein by reference.

### FIELD OF THE INVENTION

This invention relates to electrical devices in general, and more particularly to battery-powered electrical devices and batteries for the same.

### BACKGROUND OF THE INVENTION

Portable two-way radios are well known in the art, and are generally powered by batteries which make a “hard contact” connection, i.e., a casing-to-casing, electrical contact-to-electrical contact connection.

Some portable two-way radios are used for secure purposes, e.g., for military and national security applications. Due to the fact that these portable two-way secure radios must be used over a secure network, they are generally encoded with a unique, device-specific identification key. This identification key is used to permit, or deny, access to a secure radio network. More particularly, when a specific radio is to be permitted access to the secure network, the network authorizes the appropriate identification key for that radio, and the radio is then granted access to the network. However, if the network does not authorize the appropriate identification key for that specific radio, the radio will be denied access to the secure network. Thus, only those radios which have an authorized identification key, i.e., those which have been “key-enabled”, are granted access to the secure network.

Significantly, the secure network can also withdraw a previously-issued key authorization (i.e., the radio can be “key-disabled”) so as to de-activate a particular radio from the secure network.

Similarly, the secure network can authorize a new radio to be used over the secure network by simply key-enabling that new radio.

Thus, if any given secure radio should fall into the wrong hands, it can be quickly and easily de-activated from the secure network by simply withdrawing its key authorization. Similarly, new radios can be introduced onto the secure network by simply enabling the key authorization for that new radio.

Network activation and de-activation of a particular radio can be done through a central computer system regulating the secure network. Alternatively, network activation and de-activation of a particular radio can be done through a portable, battery-powered “key-loader.” Portable, battery-powered key-loaders are particularly useful for permitting network activation and de-activation of radios while in the field. These portable key-loaders, like the secure radios, are also generally powered by batteries which make a hard contact connection, i.e., a casing-to-casing, electrical contact-to-electrical contact connection.

See, for example, FIG. 1 which shows secure radios (SR₁, SR₂, SR₃) powered by secure radio batteries (SRB), and a key-loader (K) powered by a key-loader battery (KB).

By way of example but not limitation, one such commercially-available key-activated secure portable radio is the Motorola XTS 3000/5000 radio, and one such portable key-loader is the Motorola KVL 3000/3000+Key-loader.

Unfortunately, the batteries for the secure radios are generally not interchangeable with the batteries for the portable key-loaders. This is because the secure radio batteries and the portable key-loaders have different “form-fit” factors, i.e., different casing geometries and different electrical contact configurations. By way of example but not limitation, the battery for the Motorola XTS 3000/5000 radio is not interchangeable with the battery for the Motorola KVL 3000/3000+Key-loader. As a result, the secure networks must generally have an adequate supply of both types of batteries available (i.e., radio batteries and key-loader batteries). This can present a significant inventory issue, particularly in the field.

Additionally, both the batteries for the secure radios and the batteries for the portable key-loaders are generally rechargeable, which raises additional issues due to the need for two different types of battery chargers (i.e., one charger for the radio battery and one charger for the key-loader battery).

Furthermore, high-capacity batteries have recently been developed to power secure radios. By way of example but not limitation, the H8610-Li 4000 mAh rechargeable lithium ion battery was recently developed by Honeywell Batteries of Natick, Mass. to power the Motorola XTS 3000/5000 radio. These high capacity batteries offer substantially better power capacity without suffering from any significant disadvantages. Thus, these high capacity batteries (e.g., the H8610-Li 4000 mAh rechargeable lithium ion battery sold by Honeywell Batteries) have become widely accepted in the field. It would be highly advantageous if these high-capacity secure radio batteries could power the corresponding portable key-loader as well as the secure radio. However, this is currently not possible, due to the incompatibilities of the respective hard-contact connections between the secure radio battery and the portable key-loader (e.g., between the Honeywell Batteries H8610-Li 4000 battery and the Motorola KVL 3000/3000+Key-loader).

Thus there is an urgent need for a novel approach to make secure radio batteries compatible with portable key-loaders.

### SUMMARY OF THE INVENTION

The present invention provides a novel adapter which can be used to establish the hard-contact connections necessary to use secure radio batteries to power portable key-loaders.

In a preferred form of the invention, there is provided a novel adapter which can be used to establish the hard-contact connections to use the Honeywell Batteries H8610-Li 4000 radio battery to power the Motorola KVL 3000/3000+Key-loader.

The present invention also provides a novel adapter which can used to establish the hard-contact connections necessary to use batteries and electrical devices having different form-fit factors, i.e., otherwise-incompatible casing geometries and electrical contact configurations.

In one preferred form of the present invention, there is provided a battery adapter, the battery adapter comprising:

a body having a first portion and a second portion, wherein the first portion is configured so as to mechanically and electrically connect to an electrical device, and the second portion is configured so as to mechanically and electrically connect to a battery, wherein the electrical device and the battery are characterized by different form-fit factors;

wherein the first portion is electrically connected to the second portion so that a battery connected to the second portion can power an electrical device connected to the first portion.

In another preferred form of the present invention, there is provided an electrical system comprising:

an electrical device;

a battery; and

a battery adapter, the battery adapter comprising:
a body having a first portion and a second portion, wherein the first portion is configured so as to mechanically and electrically connect to the electrical device, and the second portion is configured so as to mechanically and electrically connect to the battery, wherein the electrical device and the battery are characterized by different form-fit factors;

wherein the first portion is electrically connected to the second portion so that the battery connected to the second portion can power the electrical device connected to the first portion.

In another preferred form of the present invention, there is provided a method for powering an electrical device with a battery, the method comprising the steps of:

providing an electrical device;

providing a battery; and

providing a battery adapter, the battery adapter comprising:
a body having a first portion and a second portion, wherein the first portion is configured so as to mechanically and electrically connect to an electrical device, and the second portion is configured so as to mechanically and electrically connect to a battery, wherein the electrical device and the battery are characterized by different form-fit factors;
wherein the first portion is electrically connected to the second portion so that a battery connected to the second portion can power an electrical device connected to the first portion;

mechanically and electrically connecting the battery adapter to the electrical device; and

mechanically and electrically connecting the battery to the battery adapter so as to power the electrical device.

In another preferred form of the present invention, there is provided a battery adapter, the battery adapter comprising:

a body having a first portion and a second portion, wherein the first portion is configured so as to mechanically and electrically connect to an electrical device, and the second portion is configured so as to mechanically and electrically connect to a battery;

wherein the first portion is electrically connected to the second portion so that a battery connected to the second portion can power an electrical device connected to the first portion;

and further wherein the battery adapter further comprises the logic circuitry associated with a smart battery, in order that the battery adapter can provide smart battery functionality when the battery comprises a non-smart battery.

In another preferred form of the present invention, there is provided an electrical system comprising:

an electrical device;

a battery; and

a battery adapter, the battery adapter comprising:
a body having a first portion and a second portion, wherein the first portion is configured so as to mechanically and electrically connect to the electrical device, and the second portion is configured so as to mechanically and electrically connect to the battery;
wherein the first portion is electrically connected to the second portion so that the battery connected to the second portion can power the electrical device connected to the first portion;
and further wherein the battery adapter further comprises the logic circuitry associated with a smart battery, in order that the battery adapter can provide smart battery functionality when the battery comprises a non-smart battery.

In another preferred form of the present invention, there is provided a method for powering an electrical device with a battery, the method comprising the steps of:

providing an electrical device;

providing a battery; and

providing a battery adapter, the battery adapter comprising:
a body having a first portion and a second portion, wherein the first portion is configured so as to mechanically and electrically connect to an electrical device, and the second portion is configured so as to mechanically and electrically connect to a battery;
wherein the first portion is electrically connected to the second portion so that a battery connected to the second portion can power an electrical device connected to the first portion;
and further wherein the battery adapter further comprises the logic circuitry associated with a smart battery, in order that the battery adapter can provide smart battery functionality when the battery comprises a non-smart battery;

mechanically and electrically connecting the battery adapter to the electrical device; and

mechanically and electrically connecting the battery to the battery adapter so as to power the electrical device.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic diagram showing secure radios (SR₁, SR₂, SR₃) powered by secure radio batteries (SRB), and a key-loader (K) powered by a key-loader battery (KB);

FIGS. 2-4 show an exemplary secure radio (with battery removed);

FIGS. 5-8 show an exemplary secure radio battery of the sort used to power the exemplary secure radio shown in FIGS. 2-4;

FIGS. 9-12 show an exemplary key-loader (with battery removed);

FIGS. 13-16 show an exemplary key-loader battery of the sort used to power the key-loader shown in FIGS. 9-12;

FIGS. 17-21 show a novel adapter formed in accordance with the present invention;

FIG. 22 shows the novel adapter of FIGS. 17-21 next to a key-loader, with their complementary geometries aligned;

FIG. 23 shows the novel adapter of FIGS. 17-21 mounted to the key-loader of FIG. 22;

FIG. 24 shows the novel adapter of FIGS. 17-21 mounted to the key-loader of FIG. 22, and next to a secure radio battery, with their complementary geometries aligned;

FIG. 25 shows the novel adapter of FIGS. 17-21 mounted to the key-loader of FIG. 22, and the secure radio battery of FIG. 24 in the process of being mounted to the novel adapter of FIGS. 17-21; and

FIGS. 26-31 are various views showing the secure radio battery of FIGS. 5-8 mounted to the key-loader of FIGS. 9-12 by means of the novel adapter of FIGS. 17-21.

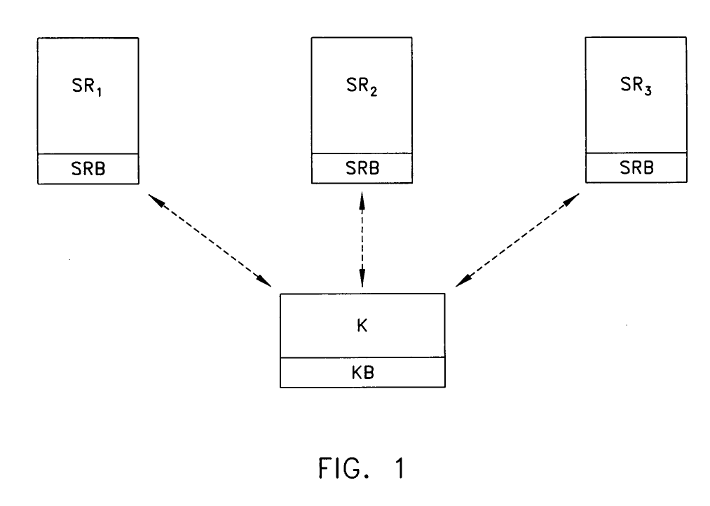

### DETAILED DESCRIPTION OF THE INVENTION

### The Secure Radio

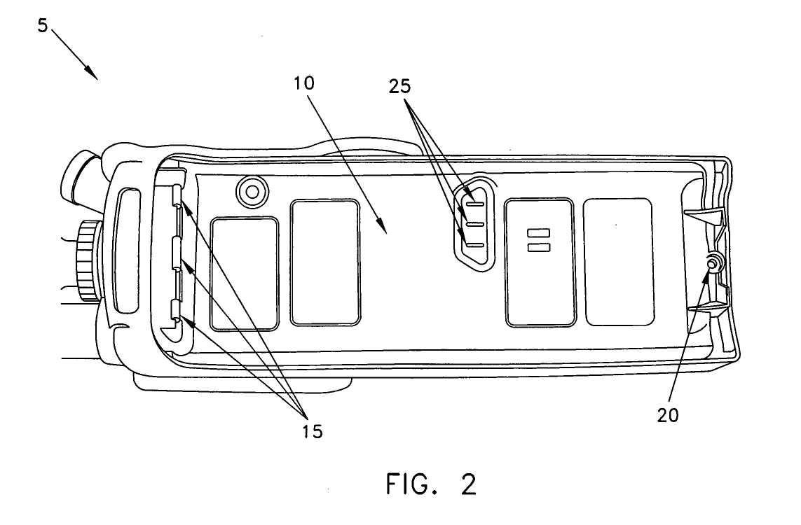

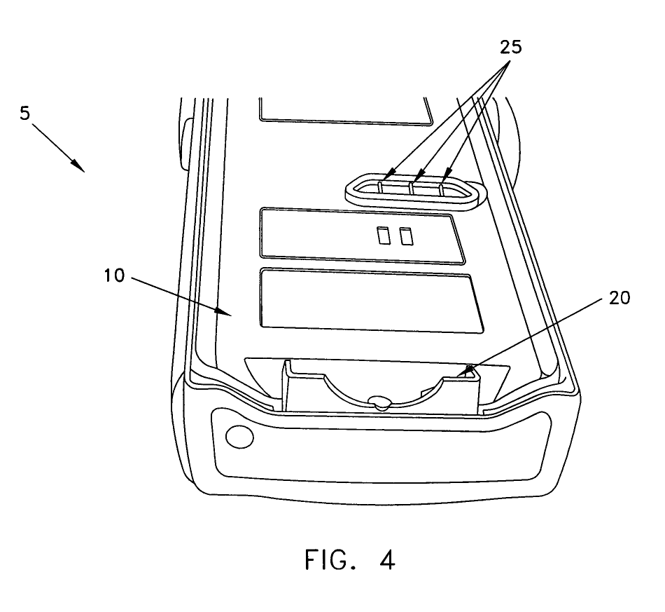

Looking now at FIGS. 2-4, there is shown an exemplary secure radio 5. Secure radio 5 is provided with a battery-receiving region 10 for mounting an associated battery to the radio, including (i) a plurality of mechanical locators 15, and a latch seat 20, for physically mounting a battery to secure radio 5, and (ii) a plurality of electrical contacts 25 for electrically connecting the battery to secure radio 5.

By way of example but not limitation, secure radio 5 may comprise the Motorola XTS 3000/5000 radio, in which case three mechanical locators 15, and three electrical contacts 25, are provided. In the case of other secure radios, a different number of mechanical locators 15, and/or a different number of electrical contacts 25, with similar or different configurations, may be provided.

### The Secure Radio Battery

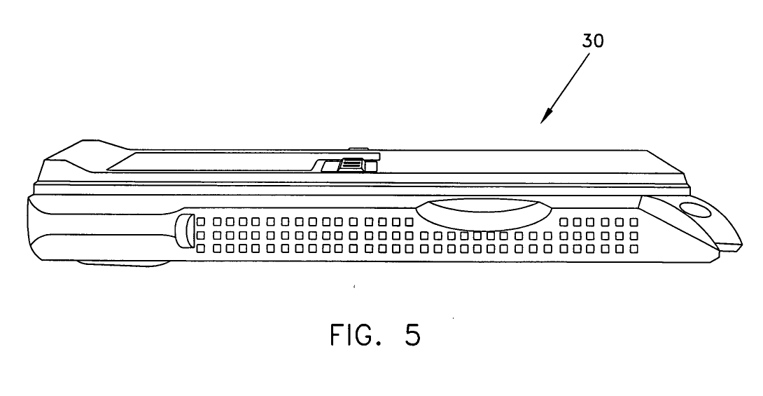

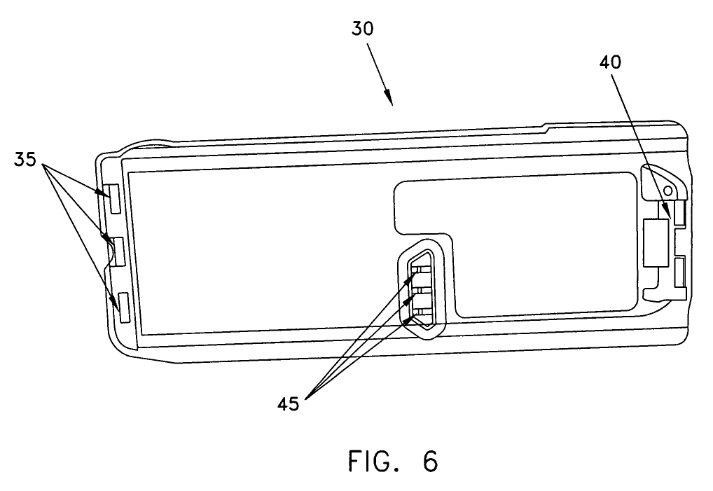

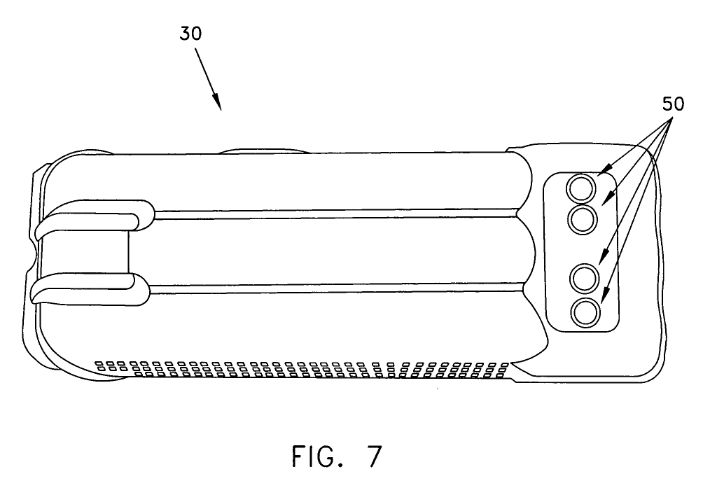

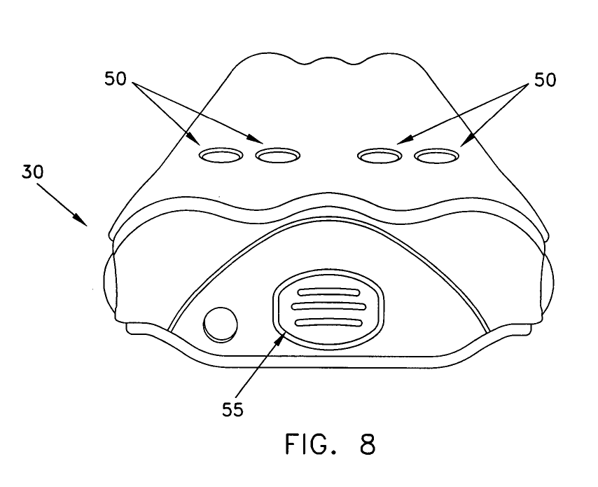

Looking next at FIGS. 5-8, there is shown an exemplary secure radio battery 30 for use in powering secure radio 5. Secure radio battery 30 is configured so as to have an exterior geometry which is complementary to the battery-receiving region 10 of secure radio 5, including (i) a plurality of locator seats 35 which are complementary to the plurality of mechanical locators 15 of secure radio 5, and a latch 40 which is complementary to radio latch seat 20, and (ii) a plurality of electrical contacts 45 which are complementary to the plurality of electrical contacts 25 on secure radio 5. Secure radio battery 30 is also provided with a plurality of external charging contacts 50 on one or more outer surfaces of the battery for recharging the battery. Secure radio battery 30 is also provided with a release button 55 which allows an operator to release secure radio battery 30 from battery receiving region 10 of secure radio 5.

By way of example but not limitation, secure radio battery 30 may comprise the Honeywell Batteries H8610-Li 4000 mAh rechargeable lithium ion battery, in which case three locator seats 35, three electrical contacts 45, and four external charging contacts 50, are provided. In the case of other secure radio batteries, a different number of locator seats 35, and/or a different number of electrical contacts 45, and/or a different number of external charging contacts 50, with similar or different configurations, may be provided. Of course, the configuration of secure radio battery 30 must be complementary to secure radio 5, in both a mechanical and electrical sense.

### The Key-Loader

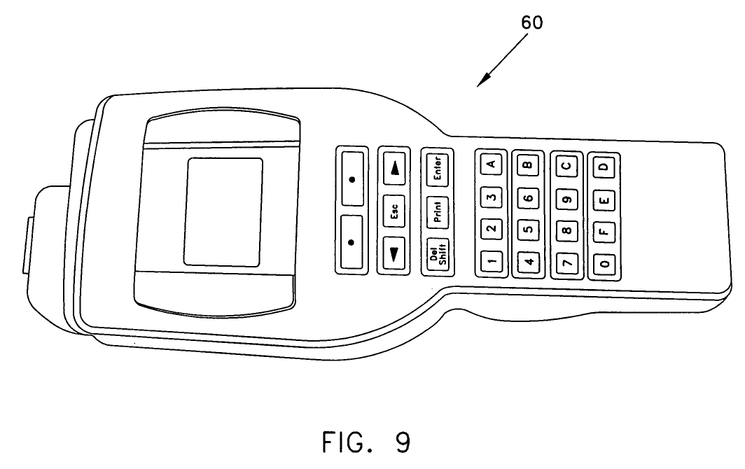

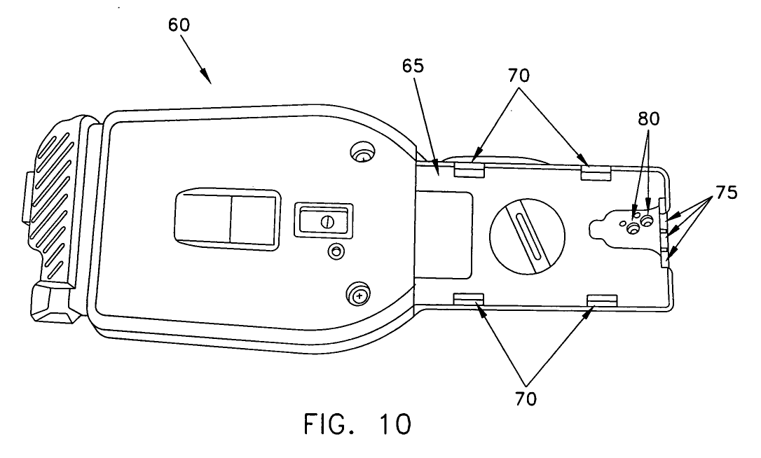

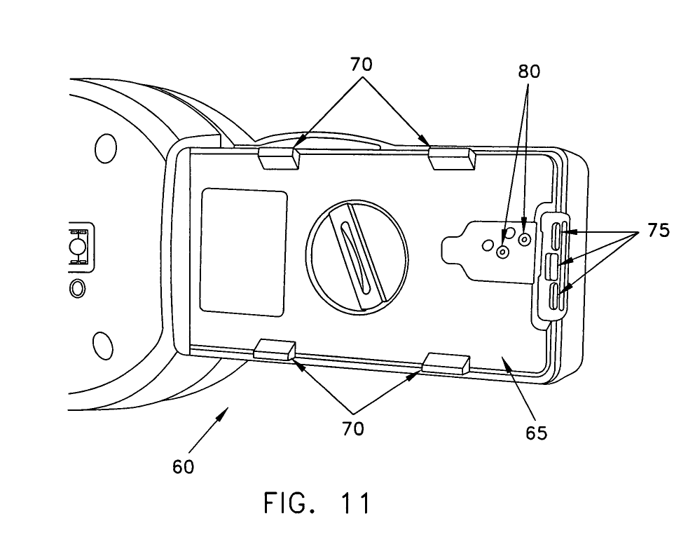

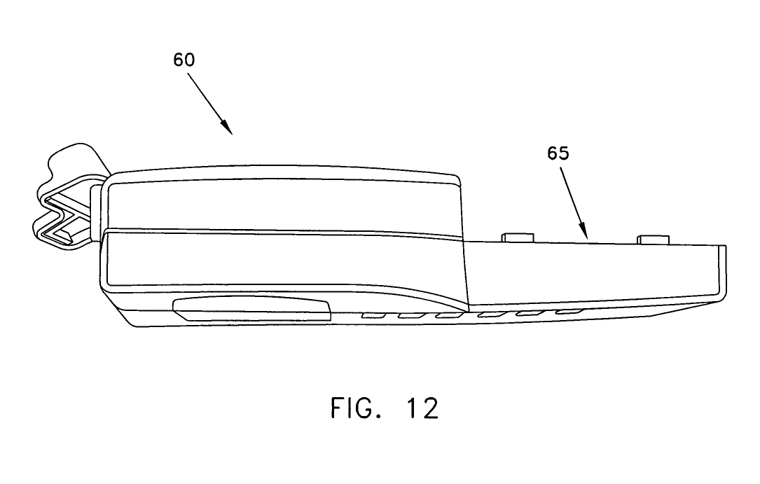

Looking next at FIGS. 9-12, there is shown an exemplary key-loader 60. Key-loader 60 is provided with a battery-receiving region 65 for mounting an associated battery to the key-loader, including (i) a plurality of rails 70 and a latch seat 75 for physically mounting an associated battery to key-loader 60, and (ii) a plurality of electrical contacts 80 for electrically connecting the battery to key-loader 60.

By way of example but not limitation, key-loader 60 may comprise the Motorola KVL 3000/3000+Key-loader, in which case four rails 70, and two electrical contacts 80, are provided. In the case of other key-loaders, a different number of rails 70, and/or a different number of electrical contacts 80, with similar or different configurations, may be provided.

### The Key-Loader Battery

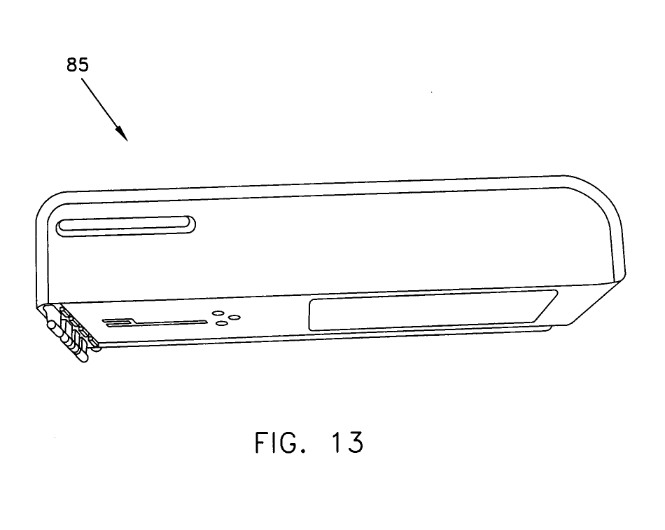

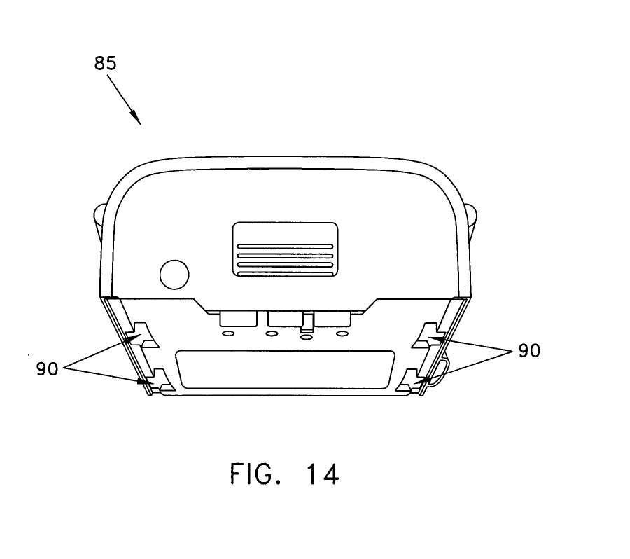

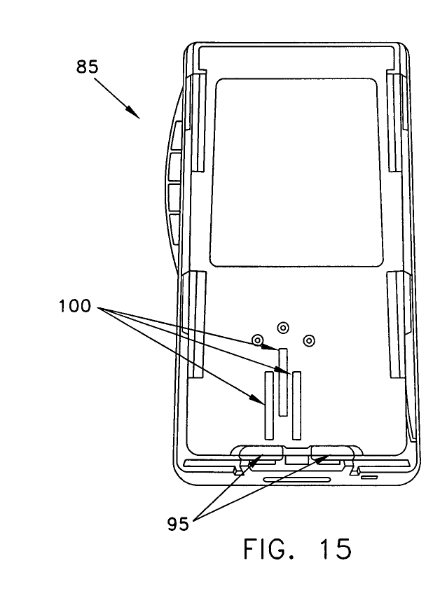

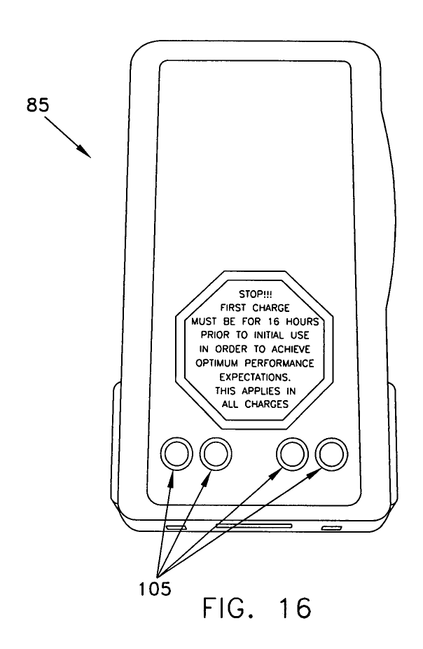

Looking next at FIGS. 13-16, there is shown an exemplary key-loader battery 85 for use in powering key-loader 60. Key-loader battery 85 is configured so as to have an exterior geometry which is complementary to battery-receiving region 65 of key-loader 60, including (i) a plurality of rail seats 90 which are complementary to the plurality of rails 70 of key-loader 60, and latch fingers 95 which are complementary to latch seat 75 of key-loader 60, and (ii) a plurality of electrical contacts 100 (only two of which are used in the construction shown) which are complementary to the plurality of electrical contacts 80 on key-loader 60. Key-loader battery 85 is also provided with a plurality of external charging contacts 105 on one or more outer surfaces of the battery for recharging the battery.

By way of example but not limitation, key-loader battery 85 may comprise the Motorola NTN7394B 7.5 V nickel metal hydride battery, in which case four rail seats 90, latch fingers 95, three electrical contacts 100, and four external charging contacts 105, are provided. In the case of other key-loader batteries, a different number of rail seats 90, and/or a different number of latch fingers 95, and/or a different number of electrical contacts 100, and/or a different number of external charging contacts 105, with similar or different configurations, may be provided. Of course, the configuration of key-loader battery 85 must be complementary to key-loader 60, in both a mechanical and electrical sense.

### The Novel Adapter of the Present Invention

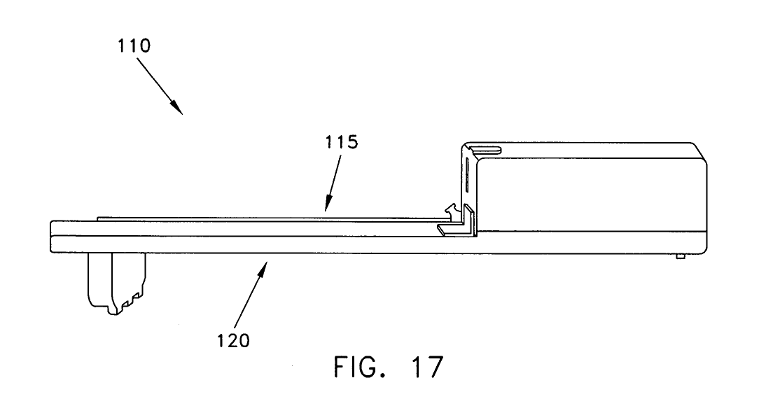

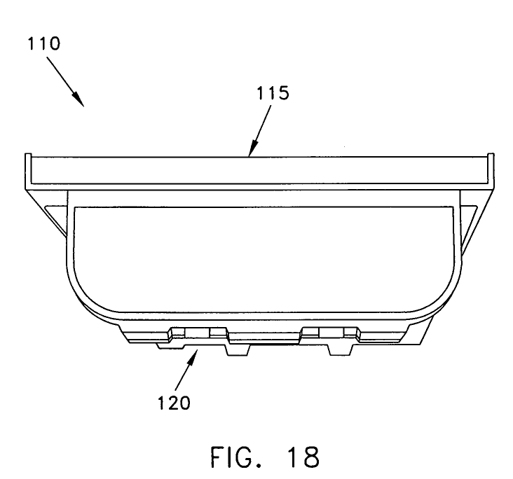

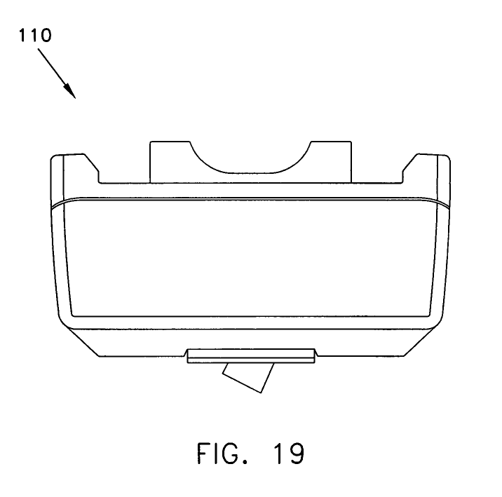

Looking next at FIGS. 17-21, there is shown a novel adapter 110 which may be used to hard contact mount secure radio battery 30 to key-loader 60.

Novel adapter 110 is configured for hard contact mounting to key-loader 60 and receiving secure radio battery 30. To this end, novel adapter 110 is configured so as to have a two-sided exterior geometry, comprising (i) a key-loader side 115 which is complementary (in both a mechanical and electrical sense) to battery-receiving region 65 of key-loader 60, and (ii) a battery side 120 which is complementary (in both a mechanical and electrical sense) to secure radio battery 30.

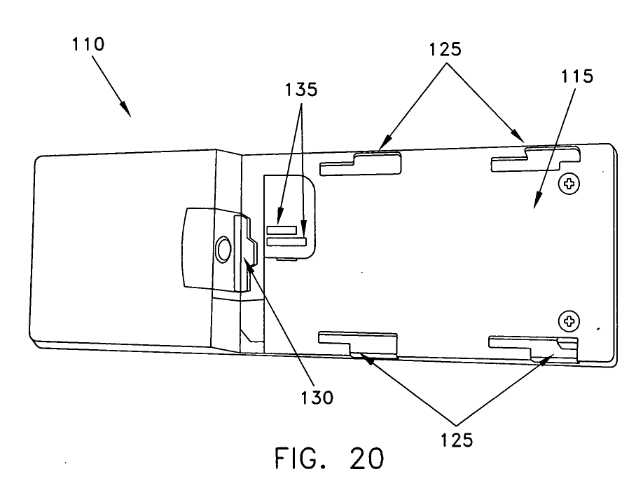

To this end and looking now at FIG. 20, key-loader side 115 of novel adapter 110 comprises: (i) a plurality of rail seats 125 which are complementary to the plurality of rails 70 of key-loader 60, and latch fingers 130 which are complementary to latch seat 75 of key-loader 60, and (ii) a plurality of electrical contacts 135 which are complementary to the plurality of electrical contacts 70 on key-loader 60.

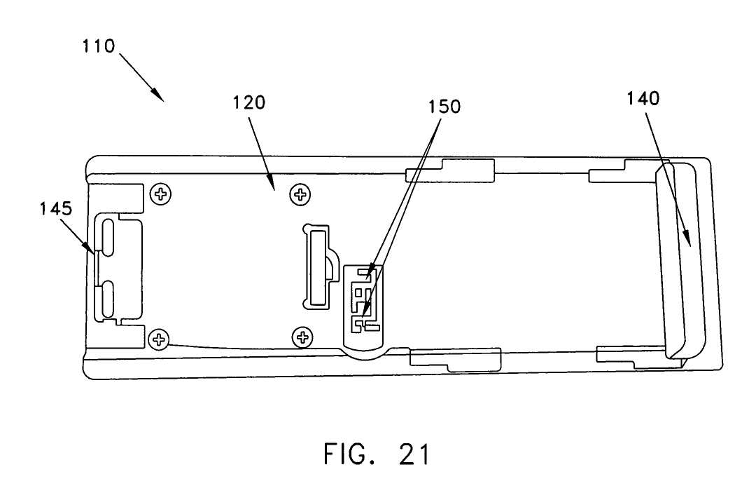

Furthermore and looking now at FIG. 21, battery side 120 of novel adapter 110 comprises: (i) a plurality of mechanical locators 140 which are complementary to the plurality of locator seats 35 of secure radio battery 30, and latch seat 145 which is complementary to latch 40 of secure radio battery 30, and (ii) a plurality of electrical contacts 150 (only two of which are used in this construction) which are complementary to the plurality of electrical contacts 45 of secure radio battery 30.

In addition to the foregoing, the adapter's plurality of electrical contacts 135 of key-loader side 115 are electrically connected to the adapter's plurality of electrical contacts of 150 of battery side 120, whereby when novel adapter 110 is mounted to key-loader 60, and a secure radio battery 30 is mounted to novel adapter 110, secure radio battery 30 may power key-loader 60.

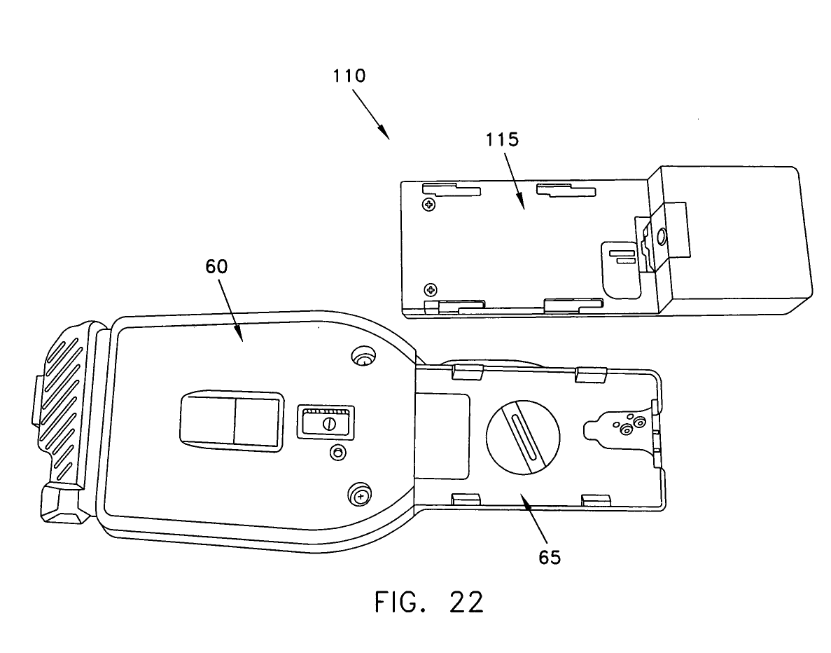

FIG. 22 shows the complementary geometries of key-loader side 115 of novel adapter 110 and battery-receiving region 65 of key-loader 60.

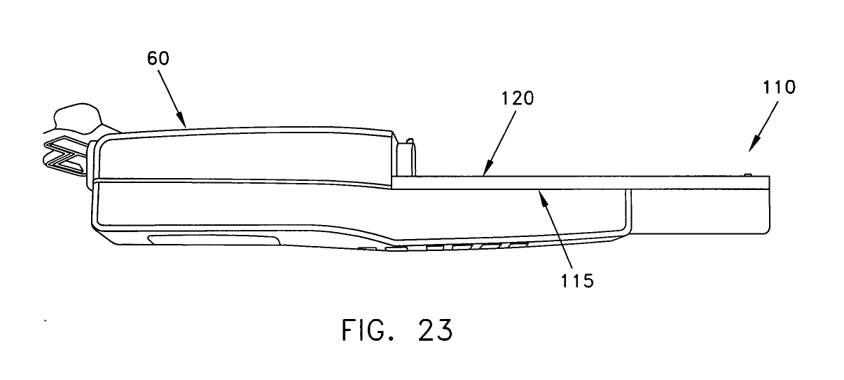

FIG. 23 shows novel adapter 110 hard contact mounted to key-loader 60.

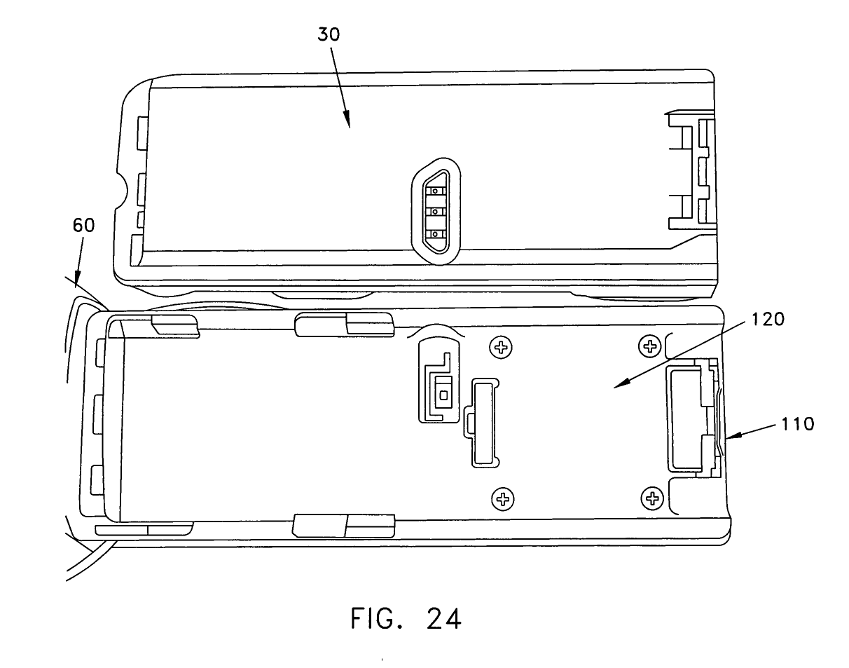

FIG. 24 shows the complementary geometries of battery side 120 of novel adapter 110 and secure radio battery 30.

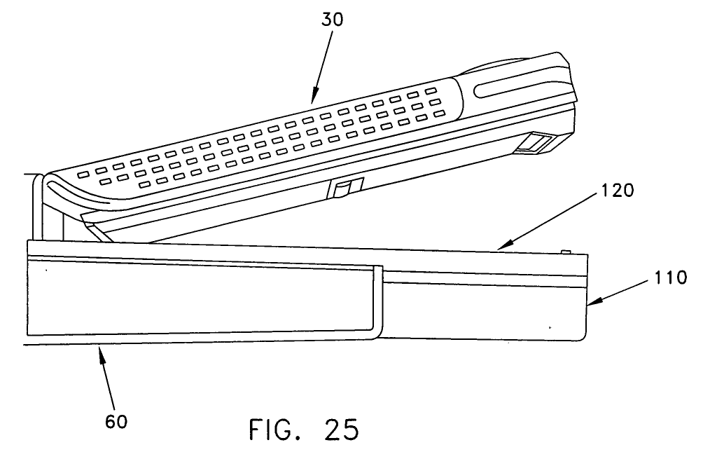

FIG. 25, shows secure radio battery 30 in the process of being mounted to the battery side 120 of novel adapter 110, with key-loader side 115 of novel adapter 110 already hard contact mounted to key-loader 60.

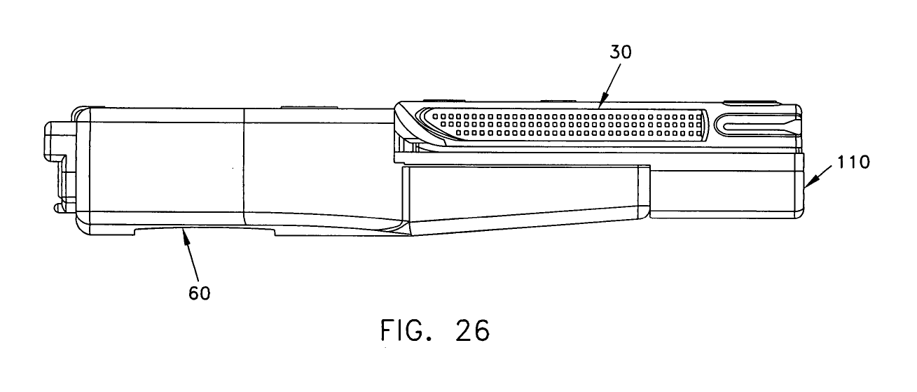

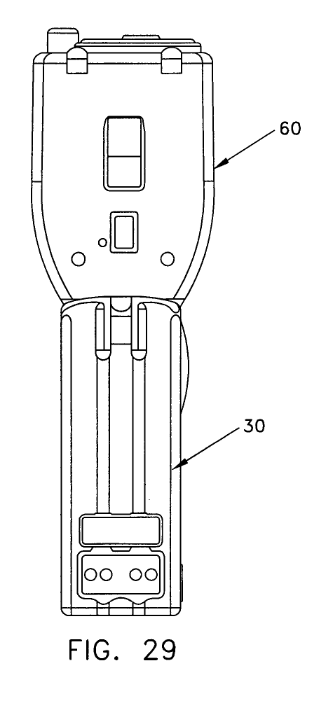

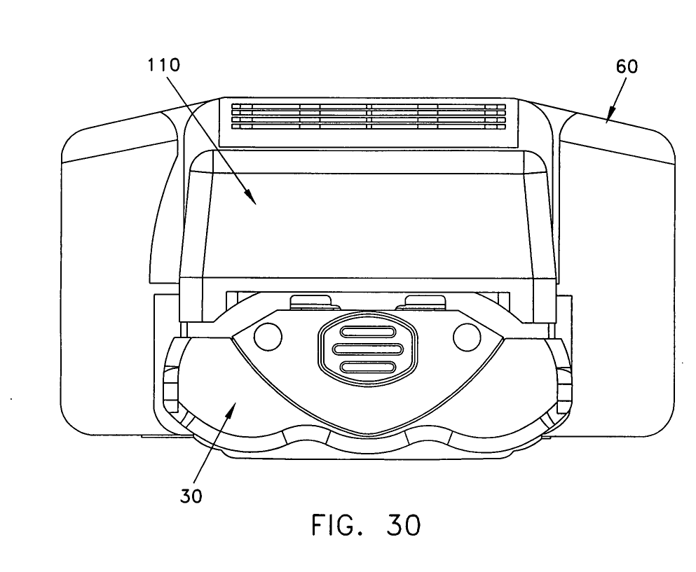

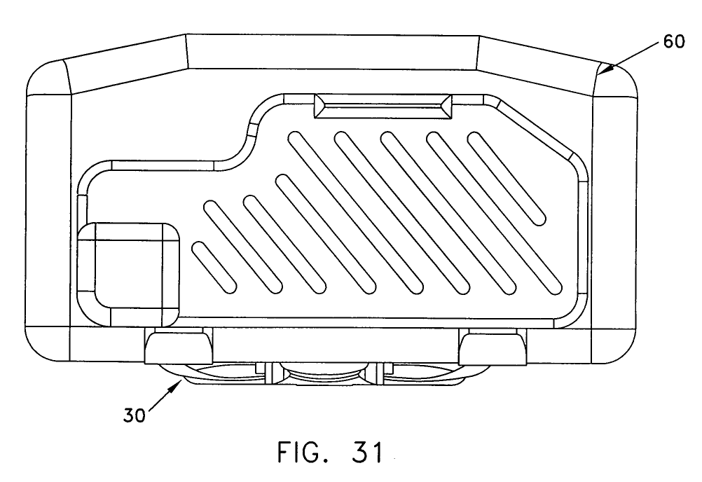

FIGS. 26-31 show the fully-connected, operational key-loader construction utilizing novel adapter 110 to mechanically and electrically connect secure radio battery 30 to key-loader 60.

Thus it will be seen that the present invention provides a novel adapter 110 which may be used to establish the hard-contact connections necessary to mechanically and electrically connect secure radio battery 30 to key-loader 60.

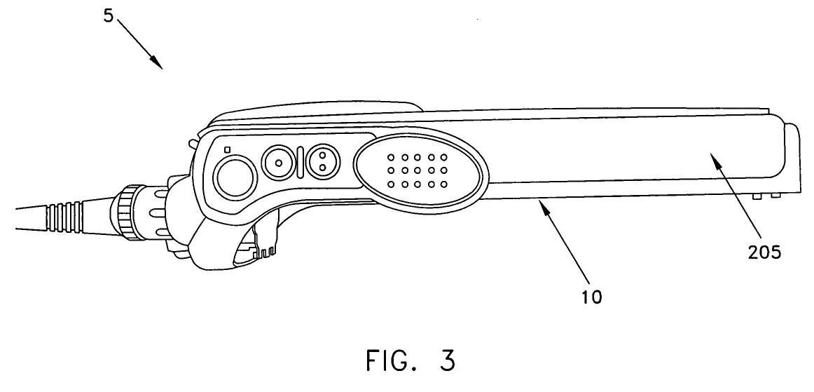

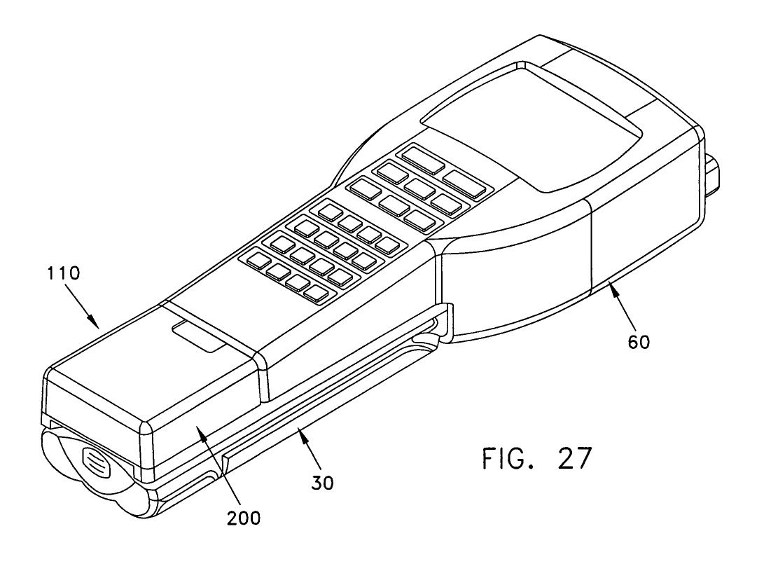

Among other things, it should also be noted that the design of novel adapter 115 permits electrical contacts 45 of secure radio battery 30 to remain externally exposed. This allows secure radio battery 30 to be recharged in its standard recharger even while secure radio battery 30 is mounted to novel adapter 110 and novel adapter 110 is mounted to key-loader 60. To this end novel adapter 110 may be configured so as to have a base portion 200 (FIG. 27) which mirrors the geometry of the base portion 205 (FIG. 3) of secure radio 5 so as to allow the fully-assembled battery/adapter/key-loader construct to sit and charge properly within the standard recharger for secure radio battery 30 (which is normally recharged while mounted to secure radio 5). In other words, the cross-sectional area of the adapter's base portion 200 is substantially identical to the base portion 205 of secure radio 5 in order to permit proper mounting of the fully-assembled battery/adapter/key-loader construct in the secure radio battery recharger.

Furthermore, it should be appreciated that novel adapter 110 can also be used with various secure radio batteries for various secure radios, regardless of cell chemistry and capacity. In other words, novel adapter 110 can be used with any other battery having the same form-fit factor, e.g., casing geometry and electrical contact configurations.

### Application to Other Batteries and/or Key-Loaders and/or Electrical Devices

It should be noted that the concepts of the present invention can also be used to fabricate adapters for use with a wide range of batteries and/or key-loaders and/or electrical devices. Thus, for example, while the foregoing invention has been described and illustrated in the context of certain exemplary batteries and key-loaders (i.e., the secure radio battery 30 comprising the Honeywell Batteries H8610-Li 4000 mAh rechargeable lithium ion battery, and the key-loader 60 comprising the Motorola KVL 3000/3000+Key-loader), the present invention is not limited to these constructions. In fact, the concepts of the present invention can be used to fabricate adapters for use with almost any batteries and/or key-loaders and/or electrical devices.

### Smart Adapters

In some situations, batteries can be provided with associated logic circuitry so as to form a “smart battery”. For example, this approach is frequently used to provide the user with information regarding remaining battery charge. In many situations, the costs associated with this additional logic circuitry can be a substantial portion of the overall cost of a smart battery. Since the additional logic circuitry is typically built into the casing of the smart battery, this costly logic circuitry is lost when the battery is discarded.

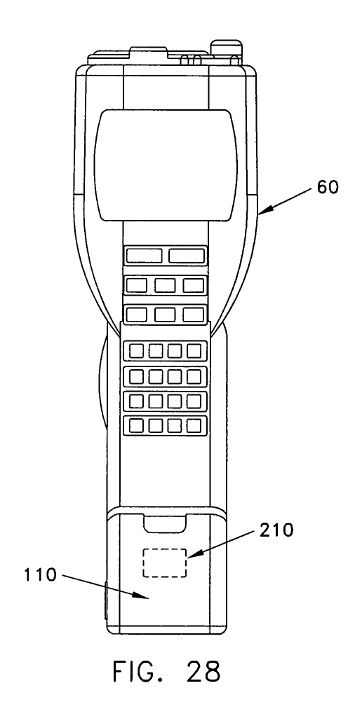

Accordingly, in another aspect of the present invention, it is contemplated that novel adapter 110 can be constructed so that the additional logic circuitry of a smart battery is carried on board the adapter itself, rather than within the casing of the battery. See, for example, FIG. 28, which shows the smart logic circuitry 210 incorporated within adapter 110. As a result of this construction, a smart battery capability can be provided even when using a “dumb” battery, since the smart logic circuitry is provided within the “smart” adapter. Furthermore, since the costly smart logic circuitry is on board the adapter, the dumb battery can be discarded without discarding the costly smart logic circuitry.

It should also be appreciated that a smart adapter (i.e., one incorporating the smart logic circuitry of a smart battery, such as the smart adapter shown in FIG. 28) might be used even where the electrical device and the battery have the same form-fit factors, in order to provide cost-efficient, reusable, smart battery function for a disposable dumb battery.

### MODIFICATIONS OF THE PREFERRED EMBODIMENTS

It will be appreciated that further embodiments of the present invention will be apparent to those skilled in the art in view of the present disclosure. It is to be understood that the present invention is by no means limited to the particular constructions herein disclosed and/or shown in the photographs, but also comprises any modifications or equivalents within the scope of the invention.

What is claimed is:

1. A battery adapter, the battery adapter comprising:
a body having a first portion and a second portion, wherein the first portion is configured so as to mechanically and electrically connect to an electrical device, and the second portion is configured so as to mechanically and electrically connect to a battery, wherein the electrical device and the battery are characterized by different form-fit factors;
wherein the first portion is electrically connected to the second portion so that a battery connected to the second portion can power an electrical device connected to the first portion.

2. A battery adapter according to claim 1 wherein:
the first portion comprises (i) a first mechanical connection mechanism configured for connection to a counterpart mechanical connection mechanism provided by the electrical device, and (ii) a first plurality of electrical contacts configured for connection to counterpart electrical contacts provided by the electrical device;
the second portion comprises (i) a second mechanical connection mechanism configured for connection to a counterpart mechanical connection mechanism provided by the battery, and (ii) a second plurality of electrical contacts configured for connection to counterpart electrical contacts provided by the battery; and
wherein the first plurality of electrical contacts are connected to the second plurality of electrical contacts so that a battery connected to the second portion can power an electrical device connected to the first portion.

3. A battery adapter according to claim 2 wherein:
the first mechanical connection mechanism comprises a first surface profile and a first mechanical latch for releasably interlocking to a counterpart surface profile and counterpart mechanical latch provided by the electrical device; and
the second mechanical connection mechanism comprises a second surface profile and a second mechanical latch for releasably interlocking to a counterpart surface profile and counterpart mechanical latch provided by the battery.

4. A battery adapter according to claim 1 wherein the battery adapter is connected to the electrical device and the battery in such a way so as to leave exposed electrical recharging contacts formed on the battery.

5. A battery adapter according to claim 1 wherein the battery adapter comprises a first side and an opposite second side, and further wherein the first portion is disposed on the first side and the second portion is disposed on the second side.

6. A battery adapter according to claim 1 wherein the battery adapter is configured so as to mechanically and electrically connect to an electrical device in the form of a portable key-loader, and further wherein the battery adapter is configured so as to mechanically and electrically connect to a battery in the form of a secure radio battery.

7. A battery adapter according to claim 1 wherein the battery adapter is configured so as to mechanically and electrically connect to an electrical device in the form of the Motorola KVL 3000/3000+Key-loader, and further wherein the battery adapter is configured so as to mechanically and electrically connect to a battery in the form of the Honeywell Batteries H8610-Li 4000 mAh rechargeable lithium ion battery.

8. A battery adapter according to claim 1 wherein the battery adapter further comprises the logic circuitry associated with a smart battery, in order that the battery adapter can provide smart battery functionality when it is connected to a non-smart battery.

9. An electrical system comprising:
an electrical device;
a battery; and
a battery adapter, the battery adapter comprising:
a body having a first portion and a second portion, wherein the first portion is configured so as to mechanically and electrically connect to the electrical device, and the second portion is configured so as to mechanically and electrically connect to the battery, wherein the electrical device and the battery are characterized by different form-fit factors;
wherein the first portion is electrically connected to the second portion so that the battery connected to the second portion can power the electrical device connected to the first portion.

10. An electrical system according to claim 9 wherein:
the first portion comprises (i) a first mechanical connection mechanism configured for connection to a counterpart mechanical connection mechanism provided by the electrical device, and (ii) a first plurality of electrical contacts configured for connection to counterpart electrical contacts provided by the electrical device;
the second portion comprises (i) a second mechanical connection mechanism configured for connection to a counterpart mechanical connection mechanism provided by the battery, and (ii) a second plurality of electrical contacts configured for connection to counterpart electrical contacts provided by the battery; and
wherein the first plurality of electrical contacts are connected to the second plurality of electrical contacts so that a battery connected to the second portion can power an electrical device connected to the first portion.

11. An electrical system according to claim 10 wherein:
the first mechanical connection mechanism comprises a first surface profile and a first mechanical latch for releasably interlocking to a counterpart surface profile and counterpart mechanical latch provided by the electrical device; and
the second mechanical connection mechanism comprises a second surface profile and a second mechanical latch for releasably interlocking to a counterpart surface profile and counterpart mechanical latch provided by the battery.

12. An electrical system according to claim 9 wherein the battery adapter is connected to the electrical device and the battery in such a way so as to leave exposed electrical recharging contacts formed on the battery.

13. An electrical system according to claim 9 wherein the battery adapter comprises a first side and an opposite second side, and further wherein the first portion is disposed on the first side and the second portion is disposed on the second side.

14. An electrical system according to claim 9 wherein electrical device comprises a portable key-loader, and further wherein the battery comprises a secure radio battery.

15. An electrical system according to claim 9 wherein the electrical device comprises the Motorola KVL 3000/3000+Key-loader, and further wherein the battery comprises the Honeywell Batteries H8610-Li 4000 mAh rechargeable lithium ion battery.

16. An electrical system according to claim 9 wherein the battery adapter further comprises the logic circuitry associated with a smart battery, in order that the battery adapter can provide smart battery functionality when the battery comprises a non-smart battery.

17. A method for powering an electrical device with a battery, the method comprising the steps of:
providing an electrical device;
providing a battery; and
providing a battery adapter, the battery adapter comprising:
a body having a first portion and a second portion, wherein the first portion is configured so as to mechanically and electrically connect to an electrical device, and the second portion is configured so as to mechanically and electrically connect to a battery, wherein the electrical device and the battery are characterized by different form-fit factors;
wherein the first portion is electrically connected to the second portion so that a battery connected to the second portion can power an electrical device connected to the first portion;
mechanically and electrically connecting the battery adapter to the electrical device; and
mechanically and electrically connecting the battery to the battery adapter so as to power the electrical device.

18. A method according to claim 17 wherein:
the first portion comprises (i) a first mechanical connection mechanism configured for connection to a counterpart mechanical connection mechanism provided by the electrical device, and (ii) a first plurality of electrical contacts configured for connection to counterpart electrical contacts provided by the electrical device;
the second portion comprises (i) a second mechanical connection mechanism configured for connection to a counterpart mechanical connection mechanism provided by the battery, and (ii) a second plurality of electrical contacts configured for connection to counterpart electrical contacts provided by the battery; and
wherein the first plurality of electrical contacts are connected to the second plurality of electrical contacts so that a battery connected to the second portion can power an electrical device connected to the first portion.

19. A method according to claim 17 wherein:
the first mechanical connection mechanism comprises a first surface profile and a first mechanical latch for releasably interlocking to a counterpart surface profile and counterpart mechanical latch provided by the electrical device; and
the second mechanical connection mechanism comprises a second surface profile and a second mechanical latch for releasably interlocking to a counterpart surface profile and counterpart mechanical latch provided by the battery.

20. A method according to claim 17 wherein the battery adapter is connected to the electrical device and the battery in such a way so as to leave exposed electrical recharging contacts formed on the battery.

21. A method according to claim 17 wherein the battery adapter comprises a first side and an opposite second side, and further wherein the first portion is disposed on the first side and the second portion is disposed on the second side.

22. A method according to claim 17 wherein electrical device comprises a portable key-loader, and further wherein the battery comprises a secure radio battery.

23. A method according to claim 17 wherein the electrical device comprises the Motorola KVL 3000/3000+Key-loader, and further wherein the battery comprises the Honeywell Batteries H8610-Li 4000 mAh rechargeable lithium ion battery.

24. A method according to claim 17 wherein the battery adapter further comprises the logic circuitry associated with a smart battery, in order that the battery adapter can provide smart battery functionality when the battery comprises a non-smart battery.

25. A battery adapter, the battery adapter comprising:
a body having a first portion and a second portion, wherein the first portion is configured so as to mechanically and electrically connect to an electrical device, and the second portion is configured so as to mechanically and electrically connect to a battery;
wherein the first portion is electrically connected to the second portion so that a battery connected to the second portion can power an electrical device connected to the first portion;
and further wherein the battery adapter further comprises the logic circuitry associated with a smart battery, in order that the battery adapter can provide smart battery functionality when the battery comprises a non-smart battery.

26. A battery adapter according to claim 25 wherein the electrical device and the battery are characterized by different form-fit factors.

27. A battery adapter according to claim 25 wherein the electrical device and the battery are characterized by the same form-fit factors.

28. An electrical system comprising:
an electrical device;
a battery; and
a battery adapter, the battery adapter comprising:
a body having a first portion and a second portion, wherein the first portion is configured so as to mechanically and electrically connect to the electrical device, and the second portion is configured so as to mechanically and electrically connect to the battery;
wherein the first portion is electrically connected to the second portion so that the battery connected to the second portion can power the electrical device connected to the first portion;
and further wherein the battery adapter further comprises the logic circuitry associated with a smart battery, in order that the battery adapter can provide smart battery functionality when the battery comprises a non-smart battery.

29. An electrical system according to claim 28 wherein the electrical device and the battery are characterized by different form-fit factors.

30. An electrical system according to claim 28 wherein the electrical device and the battery are characterized by the same form-fit factors.

31. A method for powering an electrical device with a battery, the method comprising the steps of:
providing an electrical device;
providing a battery; and
providing a battery adapter, the battery adapter comprising:
a body having a first portion and a second portion, wherein the first portion is configured so as to mechanically and electrically connect to an electrical device, and the second portion is configured so as to mechanically and electrically connect to a battery;
wherein the first portion is electrically connected to the second portion so that a battery connected to the second portion can power an electrical device connected to the first portion;
and further wherein the battery adapter further comprises the logic circuitry associated with a smart battery, in order that the battery adapter can provide smart battery functionality when the battery comprises a non-smart battery;
mechanically and electrically connecting the battery adapter to the electrical device; and
mechanically and electrically connecting the battery to the battery adapter so as to power the electrical device.

32. A method according to claim 31 wherein the electrical device and the battery are characterized by different form-fit factors.

33. A method according to claim 31 wherein the electrical device and the battery are characterized by the same form-fit factors.
